(19) United States
(12) Patent Application Publication
(10) Pub. No.: US 2005/0249324 A1
(43) Pub. Date: Nov. 10, 2005

(54) Rotating plasma current drive

(76) Inventor: George Bevan Kirby Meacham, Cleveland, OH (US)

Correspondence Address: MEACHAM COMPANY, 18560 PARKLAND DRIVE, SHAKER HEIGHTS, OH, 44122, US

(21) Appl. No.: 11/110,562

(22) Filed: Apr. 20, 2005

Related U.S. Application Data
(60) Provisional application No. 60/564,253, filed on Apr. 21, 2004.

(51) Int. Cl. G21B 1/00

(52) U.S. Cl. 376/133

(57) ABSTRACT

The present invention includes electromagnetic methods and apparatus to form a sustained direct current loop in a conductive fluid such as plasma for applications including gas discharge arc lamps and fusion confinement systems. The current loop is driven by rotating plasma within a stationary magnetic field perpendicular to the axis of rotation. Polyphase rotating electric or magnetic fields drive the plasma rotation, and the interaction between the rotating plasma and the stationary field forms and sustains the current loop. Plasma cooling and contamination are minimized since, unlike conventional direct current drive methods and apparatus, no electrodes contact the plasma.

### CROSS-REFERENCE TO RELATED APPLICATION

This application claims the benefit of an earlier filed provisional application 60/564,253.

### FIELD OF THE INVENTION

The present invention relates to current drive methods and apparatus to form a sustained direct current loop in a conductive fluid such as plasma for the purpose of confining and heating the plasma.

### BACKGROUND OF THE INVENTION

Plasma is a state of matter in which electrons are removed from atomic nuclei to form free electrons and ions. Plasma is electrically conductive, since both the free electrons and ions can move independently to carry charge. The free electrons and ions may recombine and release energy as electromagnetic radiation, and will heat and chemically modify solids, liquids or gases. At very high temperatures (100 million degrees K), the atomic nuclei collide with sufficient force that certain species, e.g. deuterium and tritium, fuse and release large quantities of energy. Plasmas therefore have a variety of current technological applications including visible and ultraviolet lamps, surface modification of solid materials, metal welding and cutting, and hazardous waste destruction. Fusion power production is in the research and development stage, and has not reached commercialization.

Plasma is formed by exciting the electrons of neutral atoms with heat, high intensity light, energetic particle bombardment or electric current discharge such that they are removed from the atomic nuclei. After formation, the plasma tends to diffuse into the ambient environment, reacting with solids, liquids and gases and cooling and recombining to form neutral atoms. These processes dissipate the plasma, and may damage structures. For many applications the plasma must therefore be isolated from the ambient environment and replenished to make up for energy and material losses. Containment systems typically combine a solid containment vessel with magnetic fields. The containment vessel excludes ambient air, and retains the plasma and the neutral atoms from which the plasma is formed. The magnetic fields serve to minimize plasma contact with the solid containment vessel. Since plasma is an electrically conductive fluid, it flows with little resistance along magnetic field lines, but diffuses slowly across field lines because it is retarded by the magnetic reaction forces resulting from currents induced in the plasma. For this reason, an objective in designing a magnetic containment system is to surround the plasma in a field with lines which form closed paths within the plasma confinement volume, and therefore do not provide direct escape paths along open field lines. Such measures slow, but do not stop loss or neutralization of plasma. Heat, high intensity light, energetic particle bombardment or electric current discharge may therefore be applied to replenish the plasma energy, and atoms or ions may be added to increase the plasma mass or replace lost atoms or ions.

U.S. Pat. No. 6,577,964 (Vos et al.) exemplifies a broad class of light-producing devices comprising a plasma arc between two electrodes that penetrate a solid transparent containment vessel. A gas or gas mixture fills the free volume within the containment vessel including the space between the electrodes. A voltage (AC or DC) applied to the external portions of the electrodes sets up an electric field between the electrodes within the containment vessel. Initial gas ionization is typically provided by a auxiliary means such as a heater or a spark to start the discharge. An electric current then flows between the electrodes, and further heats and ionizes the gas to form a plasma arc. A process in which electrons continuously recombine with the ions, emit photons, and are then removed again by the electric current produces light. The electric current also forms closed magnetic field lines surrounding the plasma arc that compress the plasma radially through the I×B magnetic pinch effect. This concentrates the plasma in the zone between the electrodes, and reduces plasma contact with the containment vessel. The pinch effect of electric currents in plasma is an important element in a number of other plasma confinement systems. While plasma discharges between metal electrodes are simple and permit both AC and DC currents, they have disadvantages. Heat transfer from the plasma to the electrodes limits the maximum achievable plasma temperature, and metal vaporized from the electrodes may change the plasma characteristics. These electrode effects are eliminated in electrode-less arc lamps magnetic fields, or a combination of the two to induce a plasma arc in a transparent envelope without electrodes. Coupling means between the external power supply and the internal arc include radio frequency capacitive and radio frequency inductive coupling and microwaves. While capacitive and microwave coupling typically form relatively unstructured plasmas, inductive coupling typically forms an alternating current loop in the plasma. Similarly to arcs formed by discharges between electrodes, the plasma is compressed and contained by the I×B magnetic pinch effect, wherein the closed magnetic field lines form a toroid enclosing the current loop. By its nature, inductive coupling can only form alternating or transient current loops, and cannot form a direct current loop.

It is known to form plasma discharges using microwaves in atmospheric pressure air without a sealed containment vessel. U.S. Pat. No. 6,661,552 (Brandenburg, et al.) describes microwave formation of plasmas that are sustained for as long as the microwave source is turned on, and persist for up to 200 milliseconds after the microwave source is turned off. Introduction of gas to the plasma as a jet forms a vortex flow structure that stabilizes the plasmas. Applications cited include light sources, chemical waste incineration, and emulation of ball lightning phenomena.

The inductive coupling principle is also used to form plasma current loops in magnetic confinement nuclear fusion devices. Tokamak devices, the largest and most advanced magnetic confinement systems, are described in Plasma Physics for Nuclear Fusion Revised Edition, pp. 529-532, The MIT Press, Cambridge 1987 (K. Miyamoto). Alternative magnetic confinement systems are described in U.S. Pat. No. 4,436,691 (Jardin); “Review of Spheromak Research”, Plasma Physics and Controlled Fusion, Vol. 36, pp. 945-990, 1994 (Thomas R. Jarboe); and “Field Reversed Configurations”, Nuclear Fusion, Vol. 28, No. 11, pp. 1988 (M. Tuszewski). These fusion devices cannot sustain a DC current indefinitely by direct inductive processes alone, but indirect processes are described for the inductive and conical theta pinch spheromak formation approaches referenced above. In one such process an inductive current transient forms a plasma current in a plasma volume, and then the plasma is moved away from the formation area. The movement causes magnetic reconnection that results in a closed current loop that is no longer inductively linked with the original formation field. This process may be repeated rapidly to form a sequence of current loops that merge with and sustain a preexisting direct current loop.

It is known to form or sustain direct current loops by using momentum or pressure to force plasma across magnetic field lines in directions such that the resulting B×V electromotive force generates a new current loop or increases an existing current loop. Radial leakage of plasma out through the poloidal field lines of tokamaks adds to the toroidal current after the initial inductive formation. New plasma must be introduced by neutral plasma beams or similar means to maintain steady-state operation. This “bootstrap” effect is described in Plasma Physics for Nuclear Fusion Revised Edition, pp. 224-226 referenced above. U.S. Pat. No. 5,923,716 (Meacham) by the present inventor describes pressure or momentum driven direct current loop formation in which plasma enters a converging magnetic field and generates a circular electromotive force. The plasma flow must be provided by neutral plasma beams or similar means. It is also known to form or sustain direct current loops by injection of ion beams transversely to a solenoidal magnetic containment field such that the ions are deflected into a circular path. This approach is described in U.S. Pat. No. 6,664,740 (Rostoker et al.).

It is known to use time-varying magnetic fields to accelerate the plasma electrons relative to the positive nuclei and create a steady-state direct current loop within the plasma. Time-varying magnetic fields are used in the rotamak confinement scheme, a variation of the spheromak. Rotomaks are described in P. M. Bellan, “Particle Confinement in Realistic 3D Rotamak Equilibria”, Physical Review Letters, Vol. 62, No. 21 pp. 2464-2467 (1989) and H. Y. Guo et al., “Formation and Steady-State Maintenance of Field Reversed Configuration Using Rotating Magnetic Field Current Drive”, Physics of Plasmas, Vol. 9, No. 21 pp. 185-200 (2002). A rotating magnetic field is generated by a set of polyphase coils carrying alternating current analogous to the coils of a polyphase induction motor. The coils are arranged around the axis of an open solenoidal magnetic containment field such that the rotational axis of the rotating magnetic field is parallel to the solenoidal magnetic containment field axis. Electrical eddy currents are induced in the plasma and rotate in synchronism with the rotating magnetic field, but with an angular phase lag. The rotating magnetic field attracts the magnetic field formed by the phase-shifted eddy currents, and applies torque to the plasma charge carriers of the eddy currents and causes them to rotate as a ring around the solenoidal magnetic containment field axis. The ring slips relative to the rotating magnetic field and rotates more slowly. Initially the charge carriers are predominantly electrons since electrons are lighter and more mobile that the positively charged ions, and the rotating ring is therefore a direct electron current. The ring current is large enough that it forms its own closed poloidal magnetic confinement field within the open solenoidal magnetic containment field. Over time, however, the heavier positively charged ions also respond to the rotating magnetic field. They are rotated in the same direction as the electrons, reducing the net ring current and its associated magnetic confinement field. In the limit in which the electrons and the ions move at the same speed, there is simply a rotating plasma within the open solenoidal magnetic containment field without its own closed magnetic confinement field. Transverse injection of ion beams to counter the ion rotation is described as a possible solution.

It is also known to use time-varying electric fields to move plasma. Charged particles, ions, electrons or positrons, may be stored for log time periods, minutes to days, as a non-neutral low density plasma in a Penning trap. The Penning trap includes a solenoidal magnetic containment field in which the charged particles make circular orbits in planes perpendicular to the axis of the magnetic field. In theory, the particles will orbit indefinitely, but in practice the orbits decay because of various losses. A rotating electric field formed by electrode pairs positioned around the Penning trap and energized by polyphase alternating voltages is described in H. -P. Huang et al., “Steady-State Confinement of Non-neutral Plasmas by Rotating Electric Fields”, Physical Review Letters, Vol. 78, No. 5 pp. 875-878 (1997). The rotating electric field perturbs the plasma and couples to the perturbation, thus transferring torque to the particles and sustaining or increasing their orbital speed. Non-neutral plasmas in Penning traps are limited to densities far lower than required for discharge lamp or fusion applications, but serve to illustrate polyphase plasma rotation. Polyphase electric fields may also be used to move dense, partially ionized gases including atmospheric pressure air. U.S. Pat. No. 6,200,539 (Sherman et al.) describes use of polyphase electric fields to pump air and modify the performance of aerodynamic surfaces.

In conclusion, prior art means of forming and sustaining direct current loops in plasma generally require an indirect process in which plasma is energized in the form of e.g. high velocity plasma beams that then merge with the current loop. There is therefore a need for a simpler and more direct means of forming and sustaining direct current loops in plasma.

### SUMMARY OF THE INVENTION

The present invention is directed to a method for forming and sustaining a direct current loop in a plasma by an electromagnetic interaction. A polyphase rotating electromagnetic field causes at least a portion of the plasma to rotate about an axis perpendicular to the lines of an applied magnetic field passing through the plasma. The rotating conductive plasma moves across the applied field lines and generates B×V electromotive forces on the positive ions and electrons. The positive ions and electrons are moved in opposite directions to form a direct current loop that is stationary relative to the applied field and lies in a plane that includes the axis of rotation. I×B forces between the applied field and the generated current form a torque couple that slows the plasma rotation. This direct current loop formation process is analogous to motor-generator processes in rotating electrical machinery. The current loop creates its own poloidal field, and the self-interaction of the current loop with the poloidal field compresses the current-carrying plasma through the I×B pinch effect.

The invention includes two means of rotating the plasma. The first means is a polyphase rotating electric field formed by a means such as electrode pairs positioned around a rotation axis perpendicular to the magnetic containment field lines and energized by polyphase alternating voltages. The rotating electric field causes a separation of the electrons and the ions and forms a plasma dipole. Since the electric field is rotating, the plasma dipole rotates synchronously with the electric field, but with a phase lag. Because of the phase lag, there is a tangential component to the forces between the plasma particles and the rotating electric field that causes plasma rotation. The plasma slips relative to the rotating electric field and rotates more slowly. An insulating barrier, e.g. ceramic or neutral gas separates the electrodes from the plasma to prevent a direct electronic current through the plasma. Polyphase standing electromagnetic waves in a resonant cavity provide an alternative means to form rotating electric fields according to the invention. The second means is a polyphase rotating magnetic field in which the polyphase coils are arranged around a rotation axis perpendicular to the magnetic containment field lines and energized by polyphase alternating currents. Electrical eddy currents are induced in the plasma and rotate in synchronism with the rotating magnetic field, but with an angular phase lag. V×B forces between the plasma charge carriers forming the eddy currents and the rotating magnetic field cause the plasma charge carriers to rotate about the rotation axis. The plasma slips relative to the rotating magnetic field and rotates more slowly. Both electric field and magnetic field rotation methods rotationally accelerate plasma that diffuses out of the poloidal field, causing B×V forces on the positive ions and electrons such that they are reincorporated into the current loop. Both also supply energy to the plasma at a power level equal to the product of the torque and the field rotation rate.

### BRIEF DESCRIPTION OF THE DRAWINGS

The appended claims set forth those novel features that characterize the invention. However, the invention itself, as well as further objects and advantages thereof, will best be understood by reference to the following detailed description of preferred embodiments. The accompanying drawings, where like reference characters identify like elements throughout the various figures, in which:

FIG. 1 illustrates the process of forming a direct current loop in a rotating plasma according to the present invention;

FIG. 2 illustrates formation of a rotating electromagnetic field through the superposition of polyphase oscillating electromagnetic fields according to the present invention;

FIG. 3 illustrates rotation of plasma through interaction with a rotating electric field according to the present invention;

FIG. 4 illustrates rotation of plasma through interaction with a rotating magnetic field according to the present invention;

FIG. 5 illustrates a system for forming a direct current loop in a plasma rotated by a rotating electric field seal according to the present invention; and

FIG. 6 illustrates a system for forming a direct current loop in a plasma rotated by a rotating magnetic field seal according to the present invention.

### DETAILED DESCRIPTION OF THE INVENTION

Upon examination of the following detailed description the novel features of the present invention will become apparent to those of ordinary skill in the art or can be learned by practice of the present invention. It should be understood that the detailed description of the invention and the specific examples presented, while indicating certain embodiments of the present invention, are provided for illustration purposes only. Various changes and modifications within the spirit and scope of the invention will become apparent to those of ordinary skill in the art upon examination of the following detailed description of the invention and claims that follow.

The present invention relates to devices that heat and confine plasma within sustained direct current electrical discharges and methods related to establishing and sustaining such discharges. More particularly the invention relates to forming such discharges by electromagnetic processes without electrodes. The invention is described with respect to electrically neutral plasmas. However, it will be apparent to those skilled in the art that the following detailed description is similarly applicable to other systems incorporating conductive fluids. Examples of such fluids include molten salts, aqueous ionic solutions, molten metals and non-neutral plasma.

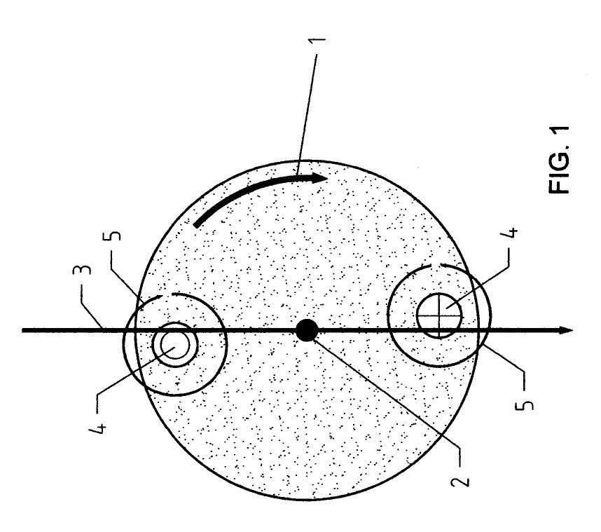

FIG. 1 illustrates plasma 1 rotating about an axis 2 perpendicular to the lines of an applied magnetic field 3 passing through the plasma, where a resultant vector is used to represent the average direction and intensity of the distributed field lines. The rotating conductive plasma 1 moves across the lines of the applied field 3 and generates B×V electromotive forces on the positive ions and electrons. The electromotive forces are “out of the paper” on one side of the axis and “into the paper” on the other, and act on the positive ions and electrons to form a direct current loop 4. The current loop is stationary relative to the applied field 3 and lies in a plane that includes the axis of rotation 2. I×B forces between the applied field 3 and the generated current loop 4 form a torque couple that slows the rotation of plasma 1. This direct current loop formation process is analogous to motor-generator processes in rotating electrical machinery, and supplies energy to the plasma to compensate for energy losses. Applied field 3 may be formed by current carrying coils or permanent magnets. The current loop 4 creates its own poloidal magnetic field 5, and the self-interaction of the current loop with the poloidal magnetic field compresses the current-carrying plasma through the I×B pinch effect. The current loop 4 is maintained even though charged particles diffuse out of the loop. These charged particles rejoin the rotating plasma 1 and interact again with applied field 3 and are moved in the same directions as the charged particles comprising current loop 4. Parallel currents are mutually attractive, causing the newly accelerated particles to merge with and sustain direct current loop 4. The overall effect of rotating plasma 1 within the applied field 3 is a process that pumps plasma into the sustained direct current loop 4 and contains the plasma in a toroidal plasma entity.

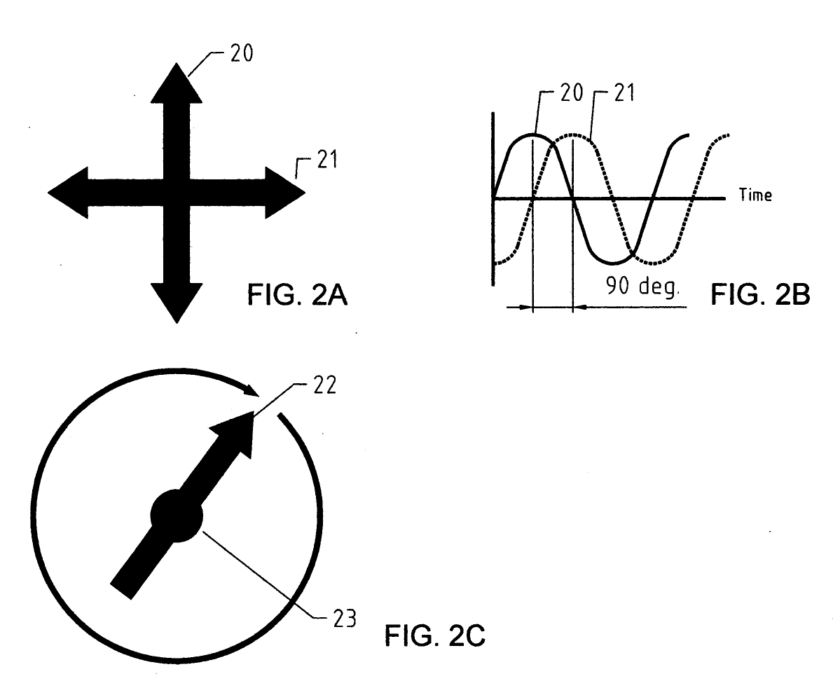

FIG. 2 illustrates a polyphase rotating electromagnetic field using a two-pole two-phase field as an example. In FIG. 2A a first phase electric or magnetic field 20 oscillates with sinusoidal amplitude in a first orientation. A second phase electric or magnetic field 21 oscillates with sinusoidal amplitude in a second orientation orthogonal to the orientation of the first phase field. Resultant vectors are used to represent the average direction and intensity of distributed field lines. FIG. 2B shows the amplitude of the first phase field 20 and the second phase field 21 versus time. The oscillation periods of the two phases are the same, while the first phase field 20 and the second phase field 21 have a phase difference of ¼ of an oscillation period or 90°. FIG. 2C shows the resultant field 22 of the first phase field 20 and the second phase field 21. The resultant field 22 rotates with constant speed and amplitude around a rotation axis 23. It is analogous to the rotating magnetic field in two-phase electric motors. As with electric motors, larger numbers of phases; e.g. three phase fields with phase differences of ⅙ of an oscillation period or 60° are possible and included in the present invention. Similarly, rotating fields with any even number of poles: e.g. four or six, are possible and included in the present invention. More generally, the rotating electromagnetic field is formed by superposition of N oscillating electromagnetic fields of the same oscillation period T, in which the direction of the resultants of each oscillating electromagnetic field within the fluid intersect at the rotation axis and subtend angles of 360°/(P×N). Each oscillating electromagnetic field is time-shifted relative to the adjacent oscillating electromagnetic field by T/(P×N).

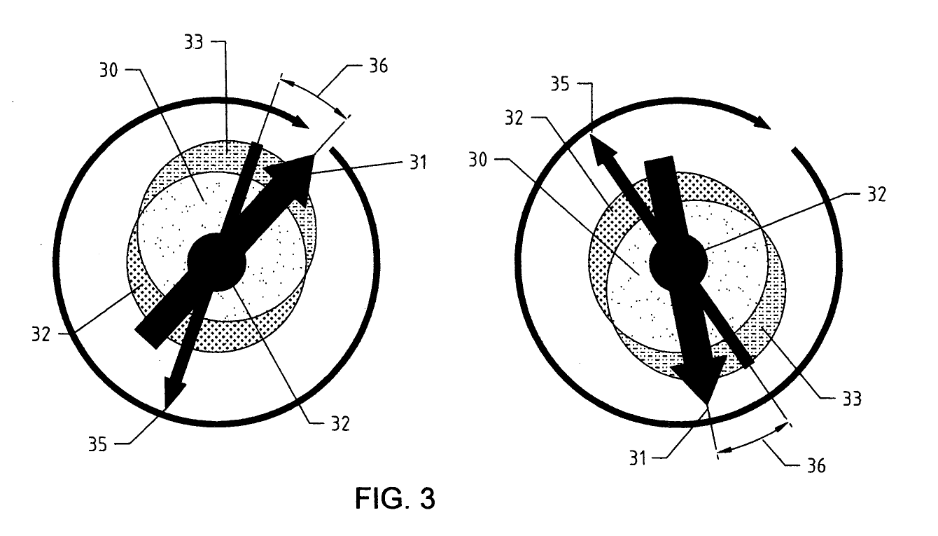

FIG. 3 illustrates a neutral plasma 30 in an electric field 31 rotating about rotational axis 32. Resultant vectors are used to represent the average direction and intensity of distributed field lines. This field shifts the electrons 33 radially relative to the ions 34, and forms a plasma dipole 35 that rotates synchronously with the electric field 31. Since this radial shift of electrons 33 relative to ions 34 is an electric current with associated inductance, there is a time lag between the application of the electric field and the motion of the charge that causes a phase angle 36 between the electric field 31 and the dipole 35. The phase angle 36 results in tangential component to the forces between the rotating electric field 31 and the electrons 33 and ions 34 that generates a torque that causes plasma rotation. The rotation of plasma 30 is slower than the rotation of electric field 31, not synchronous, because of drag forces acting on the plasma.

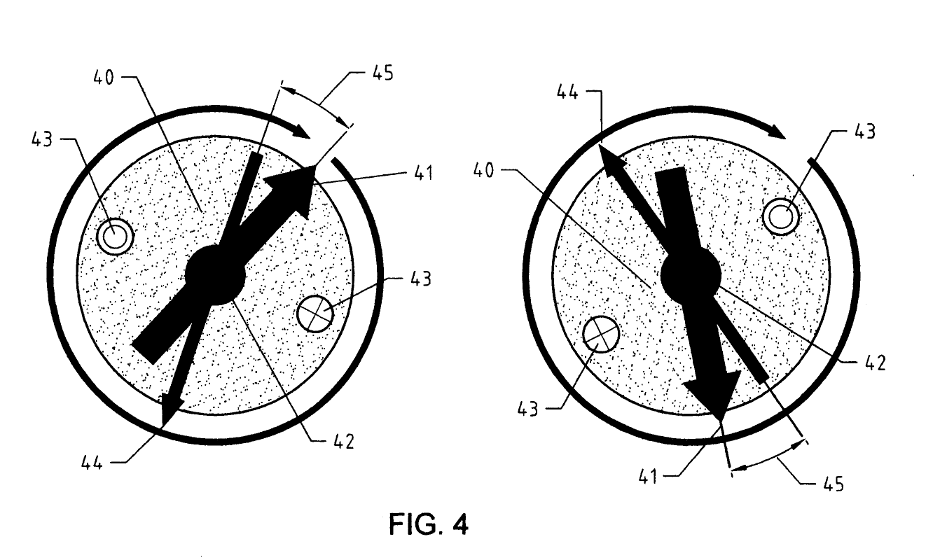

FIG. 4 illustrates a neutral plasma 40 in a magnetic field 41 wherein the plasma rotates about rotational axis 42. Resultant vectors are used to represent the average direction and intensity of distributed field lines. The lines of the rotating magnetic field 41 move through conductive plasma 40 and generate B×V electromotive forces on the positive ions and electrons. The positive ions and electrons are moved in opposite directions to generate an eddy current loop 43 that rotates synchronously with the rotating magnetic field 41 and associated magnetic field 44. Since the eddy current loop 43 has associated inductance, there is a time lag between the B×V electromotive forces generation and the motion of the charge that causes a phase angle 45 between the rotating magnetic field 41 and the eddy current loop 43. I×B forces between the eddy current loop 43 and the rotating magnetic field 41 causes the plasma 40 to rotate. The rotation of plasma 40 is slower than the rotation of electric field 41, not synchronous, because of drag forces acting on the plasma. This plasma rotation process is the same as employed in polyphase induction motors in that a rotating magnetic field induces eddy currents in a conductive rotor and drags the rotor at a non-synchronous slower speed.

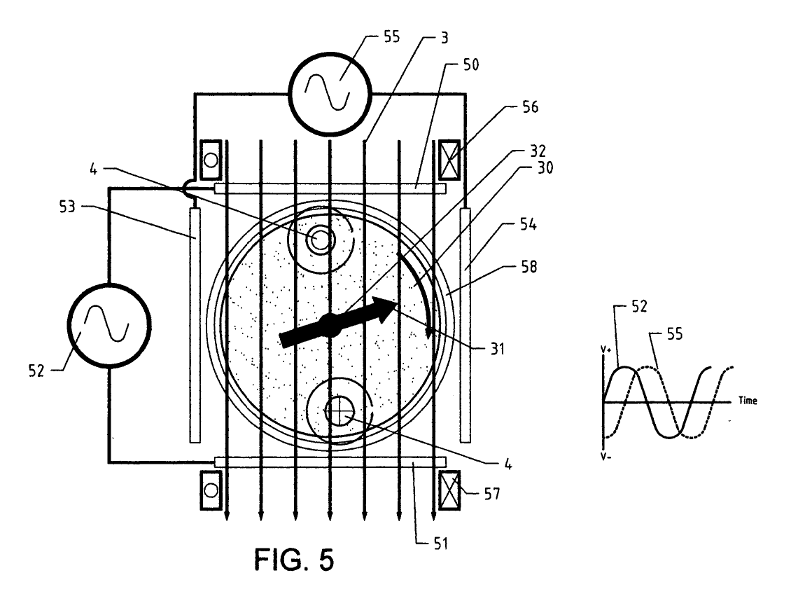

FIG. 5 show an exemplary system according to the invention for creating and maintaining a plasma current loop in which neutral plasma 30 is rotated by an electric field 31 rotating about rotational axis 32. A first pair of conductive electrode plates 50 and 51 are positioned on opposite sides of the rotation axis 32 and are electrically connected to the Phase A sinusoidal oscillating voltage source 52. A second pair of conductive electrode plates 53 and 54 are positioned on opposite sides of the rotation axis 32 and are electrically connected to the Phase B sinusoidal oscillating voltage source 55. The conductive electrode plates 53 and 54 are rotated 90° about rotation axis 32 relative to conductive electrode plates 50 and 51. The sinusoidal oscillating voltage sources 55 and 56 operate at the same frequency and with a 90° phase angle between the sinusoidal oscillating voltages. The oscillating electric fields formed between 50 and 51 and between 53 and 54 combine to form the rotating electric field 31 through the process described with reference to FIG. 2. The applied steady magnetic field 3 is formed by coils 56 and 57 positioned on opposite sides of the rotation axis 32, and energized by direct current sources (not shown). An electrically insulating shell 58 may be employed to contain the plasma and prevent electric discharges between the electrode plates 50, 51, 53, and 54. Current loop formation comprises the steps of introducing or forming a plasma within the insulating shell 58, passing current through coils 56 and 57 to form the applied magnetic field 3, and starting the sinusoidal oscillating voltage sources 55 and 56 to form the rotating electric field 31. The steps may be done in any order. The rotating electric field 31 causes plasma rotation through the process described with reference to FIG. 3, and the plasma current loop 4 is formed and sustained through the process described with reference to FIG. 1. While the principle is illustrated by a rotating electric field formed by voltages applied directly to electrode plates 50, 51, 53, and 54, these electrode plates may instead form a radio frequency resonant cavity. In this embodiment the spacing between the plates is an integral multiple of the half wavelength of the radio frequency such that orthogonal Phase A and Phase B resonant standing waves may be contained in the cavity. The Phase A and Phase B resonant standing waves are generated by a radio frequency excitation means (not shown) such that they have the same frequency and a 90° phase angle difference. The radio frequency excitation means is e.g. two separate radio frequency sources with controlled frequency and phase. Alternatively, it may be a single source with the output split to form Phase A and Phase B. In this case the Phase B travel path length to the resonant cavity differs from the Phase A travel path length by 1/ the wavelength of the radio frequency to provide the 90° phase angle difference.

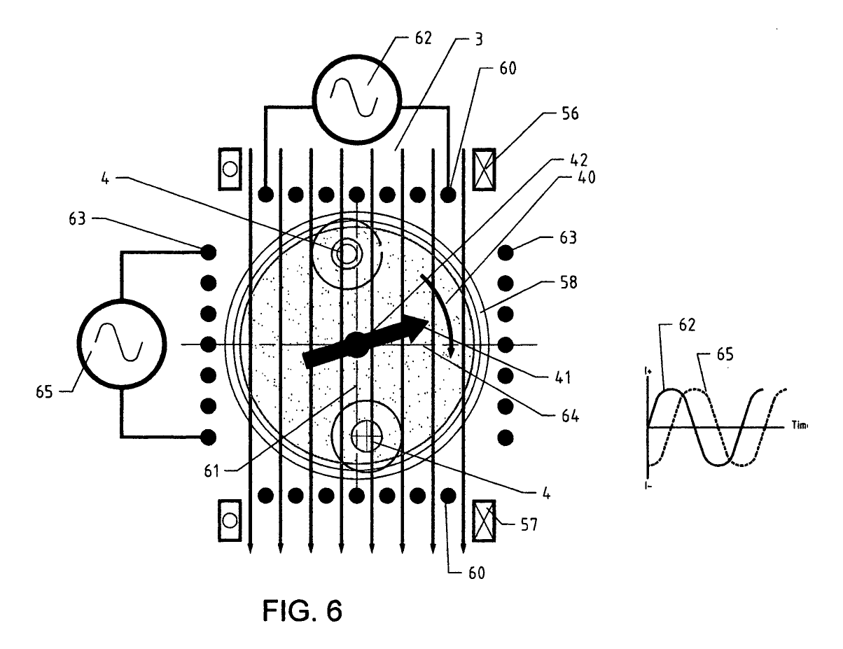

FIG. 6 show an exemplary system according to the invention for creating and maintaining a plasma current loop in which neutral plasma 40 is rotated by a magnetic field 41 rotating about rotational axis 42. A first field coil 60 has its axis 61 perpendicular to and passing through the rotation axis 42, and is electrically connected to the Phase A sinusoidal oscillating current source 62. A second field coil 63 has its axis 64 perpendicular to and passing through the rotation axis 42, and is electrically connected to the Phase A sinusoidal oscillating current source 65. Field coil 63 is rotated 90° about rotation axis 32 relative to the field coil 60. The sinusoidal oscillating current sources 62 and 65 operate at the same frequency and with a 90° phase angle between the sinusoidal oscillating currents. The oscillating magnetic fields formed by coils 60 and 63 combine to form the rotating magnetic 41 field through the process described with reference to FIG. 2. The applied steady magnetic field 3 is formed by coils 56 and 57 positioned on opposite sides of the rotation axis 42, and energized by direct current sources (not shown). An electrically insulating shell 58 may be employed to contain the plasma. Current loop formation comprises the steps of introducing or forming a plasma within the insulating shell 58, passing current through coils 56 and 57 to form the applied steady magnetic field 3, and starting the sinusoidal oscillating current sources 62 and 65 to form the rotating magnetic field. The steps may be done in any order. The rotating magnetic field causes plasma rotation through the process described with reference to FIG. 4, and the plasma current loop is formed and sustained through the process described with reference to FIG. 1.

The direct current loop generation method of the present invention is fundamentally different from the rotomak method in that the plasma rotation axis is perpendicular to the stationary applied field lines rather than parallel. This results in robust electromagnetic current generation in which the positive ions and the electrons move in opposite directions and both contribute to the current loop. In contrast, the positive ions and the electrons tend to move in the same direction in the rotomak, thus causing a net current reduction. Additional processes are therefore required to slow the ions relative to the electrons.

The present invention can provide at least the following benefits. First, it is applicable to a broad range of plasma and other conductive fluids that contain positive, negative or mixed charge carriers. Second, it provides a means of sustaining a direct current loop through purely electromagnetic energy transfer processes, without addition of energy in the form of energetic material. Third, it collects charge carriers outside the direct current loop and accelerates them such that they become part of the current loop.

The foregoing embodiments of the present invention have been presented for the purposes of illustration and description. These descriptions and embodiments are not intended to be exhaustive or to limit the invention to the precise form disclosed, and obviously many modifications and variations are possible in the light of the above disclosure. The embodiments were chosen and described in order to best explain the principle of the invention and its practical applications to thereby enable others skilled in the art to best utilize the invention in its various embodiment and with various modifications as are suited to the particular use contemplated. It intended that the invention be defined by the following claims.

1. A method for forming a sustained direct electric current loop in a conductive fluid, comprising:
rotating the conductive fluid about an axis by a rotational means;
passing a stationary magnetic field through the rotating conductive fluid, wherein the resultant of the field lines is perpendicular to the rotation axis.

2. The method of claim 1, wherein the conductive fluid is a plasma comprising electrons and positively charged ions.

3. The method of claim 1, wherein the rotational means is an electric field with an even number P of poles wherein the resultant of the field lines is perpendicular to and rotates about the conductive fluid rotation axis.

4. The method of claim 3, wherein the rotating electric field is formed by superposition of N oscillating electric fields of the same oscillation period T, wherein:
N is an integer equal to 2 or more;
the resultant of the field lines of each oscillating electric field within the fluid is perpendicular to the rotation axis;
the resultants of the field lines of each oscillating electric field intersect at the rotation axis and subtend angles of 360°/(P×N); and
each oscillating electric field is time-shifted relative to the adjacent oscillating magnetic field by T/(P×N).

5. The method of claim 4 in which the oscillating electric fields are formed by oscillating voltages applied to conductor pairs on opposite sides of the rotation axis.

6. The method of claim 5 in which an electrically insulating barrier separates the conductor pairs from the conductive fluid.

7. The method of claim 4 in which the oscillating electric fields are formed by standing electromagnetic radio frequency waves in a resonant cavity surrounding the rotation axis.

8. The method of claim 1, wherein the rotational means is a magnetic field with an even number P of poles wherein the resultants of the field lines are perpendicular to and rotate about the conductive fluid rotation axis.

9. The method of claim 8, wherein the rotating magnetic field is formed by superposition of N oscillating magnetic fields of the same oscillation period T, wherein:
N is an integer equal to 2 or more;
the resultant of the field lines of each oscillating magnetic field within the fluid is perpendicular to the rotation axis;
the resultants of the field lines of each oscillating magnetic field intersect at the rotation axis and subtend angles of 360°/(P×N); and
each oscillating magnetic field is time-shifted relative to the adjacent oscillating magnetic field by T/(P×N).

10. The method of claim 9 in which the oscillating magnetic fields are formed by oscillating electric currents flowing through magnet coil pairs on opposite sides of the rotation axis.

11. Apparatus that forms a sustained direct electric current loop in a conductive fluid, comprising:
a device to rotate the conductive fluid about an axis;
a stationary magnetic field passing through the rotating conductive fluid, wherein the resultants of the field lines are perpendicular to and rotate about the conductive fluid rotation axis.

12. The apparatus of claim 11, wherein the conductive fluid is a plasma comprising electrons and positively charged ions.

13. The apparatus of claim 11, wherein the device to rotate the conductive fluid generates an electric field with an even number P of poles having field line components perpendicular to and rotating about the conductive fluid rotation axis.

14. The apparatus of claim 13, wherein the rotating electric field is formed by superposition of N oscillating electric fields N of the same oscillation period T, wherein:
N is an integer equal to 2 or more;
the resultant of the field lines of each oscillating electric field within the fluid is perpendicular to the rotation axis;
the resultants of the field lines of each oscillating electric field intersect at the rotation axis and subtend angles of 360°/(P×N); and
each oscillating electric field is time-shifted relative to the adjacent oscillating magnetic field by T/(P×N).

15. The apparatus of claim 14 in which the oscillating electric fields are formed by oscillating voltages applied to conductor pairs on opposite sides of the rotation axis.

16. The apparatus of claim 14 in which the oscillating electric fields are formed by standing electromagnetic radio frequency waves in a resonant cavity surrounding the rotation axis.

17. The apparatus of claim 11, wherein the device to rotate the conductive fluid generates a magnetic field with an even number P of poles with field line components perpendicular to and rotating about the conductive fluid rotation axis.

18. The apparatus of claim 17, wherein the rotating magnetic field is formed by superposition of N oscillating magnetic fields of the same osillation period T, wherein:
N is an integer equal to 2 or more;
the resultant of the field lines of each oscillating magnetic field within the fluid is perpendicular to the rotation axis;
the resultants of the field lines of each oscillating magnetic field intersect at the rotation axis and subtend angles of 360°/(P×N); and
each oscillating magnetic field is time-shifted relative to the adjacent oscillating magnetic field by T/(P×N).

19. The apparatus of claim 18 in which the oscillating magnetic fields are formed by oscillating electric currents flowing through magnet coil pairs on opposite sides of the rotation axis.

20. The apparatus of claim 11, wherein the stationary magnetic field is formed by direct electric current flowing through a coil.

21. The apparatus of claim 11, wherein the stationary magnetic field is formed by permanent magnets.
